(19) United States
(12) Patent Application Publication
(10) Pub. No.: US 2022/0287048 A1
(43) Pub. Date: Sep. 8, 2022

(54) SCHEDULING TIMING FOR LARGE CELLS AND LONG PROPAGATION DELAYS

(71) Applicant: TELEFONAKTIEBOLAGET LM ERICSSON (PUBL), STOCKHOLM (SE)

(72) Inventor: Xingqin Lin, SAN JOSE, CA (US)

(21) Appl. No.: 17/635,999

(22) PCT Filed: Aug. 13, 2020
(86) PCT No.: PCT/IB2020/057651

§ 371 Date: Feb. 16, 2022

Related U.S. Application Data
(60) Provisional application No. 62/888,287, filed on Aug. 16, 2019.

(51) Int. Cl. H04W 72/12

(52) U.S. Cl. CPC H04W 72/1205; H04W 72/1278

(57) ABSTRACT

Systems and methods for scheduling timing for large cells and long propagation delays are disclosed herein. Embodiments include a method performed by a User Equipment, UE, comprising receiving, from a network node, a cell-specific offset for a scheduling timing and/or a UE-specific offset for the scheduling timing. The method further includes determining the scheduling timing based on the cell-specific offset for the scheduling timing and/or the UE-specific offset for the scheduling timing. In some embodiments the scheduling timing comprises a Hybrid Automatic Repeat Request (HARQ) feedback timing, a Physical Uplink Shared Channel (PUSCH) timing, or an RRC Connection Request (Msg3) timing. In some embodiments the method further comprises transmitting a HARQ feedback, a PUSCH, or a Msg3 in accordance with the determined scheduling timing In this manner, scheduling timing is enhanced to allow for networks with large cells and/or long propagation delays, such as the Non-Terrestrial Network (NTN).

### RELATED APPLICATIONS

This application claims the benefit of U.S. provisional patent application Ser. No. 62/888,287, filed Aug. 16, 2019, the disclosure of which is hereby incorporated herein by reference in its entirety.

### TECHNICAL FIELD

The present disclosure relates to scheduling timing of a User Equipment (UE) transmission, in response to a received transmission, in consideration of timing advance requirements in a Non-Terrestrial Network (NTN) and other networks with increased propagation delays.

### BACKGROUND

There is an ongoing resurgence of satellite communications. Several plans for satellite networks have been announced in the past few years. The target services vary, from backhaul and fixed wireless, to transportation, to outdoor mobile, and to Internet-of-Things (IoT). Satellite networks could complement mobile networks on the ground by providing connectivity to underserved areas and providing multicast/broadcast services.

To benefit from the strong mobile ecosystem and economy of scale, adapting the terrestrial wireless access technologies including Third Generation Partnership Project (3GPP) Long Term Evolution (LTE) and New Radio (NR) for satellite networks is drawing significant interest. For example, 3GPP completed an initial study in Release 15 on adapting NR to support non-terrestrial networks (mainly satellite networks), see 3GPP Technical Report (TR) 38.811 V15.0.0 (2018 Aug. 10). This initial study focused on the channel model for the non-terrestrial networks, defining deployment scenarios, and identifying the key potential impacts. 3GPP is conducting a follow-up study item in Release 16 on solutions evaluation for NR to support non-terrestrial networks, see for example “Study on solutions evaluation for NR to support non-terrestrial Network”, 3GPP tdoc RP-181370.

### Satellite Communications

A satellite radio access network usually includes the following components: a “gateway” that connects a satellite network to a core network, a “satellite” that refers to a spaceborne platform, a “terminal” that refers to user equipment (UE), a feeder link that refers to the link between a gateway and a satellite, and a service link that refers to the link between a satellite and a terminal. The link from the gateway to a terminal is often called a forward link, and the link from a terminal to the gateway is often called a return link Depending on the functionality of the satellite in the system, we can consider two transponder options: (1) a bent pipe transponder in which the satellite forwards the received signal back to the earth with only amplification and a shift between service link frequency and feeder link frequency and (2) a regenerative transponder in which the satellite includes on board processing to demodulate and decode the received signal and regenerate the signal before sending it back to the earth.

Depending on the orbit altitude, a satellite may be categorized as a low Earth orbit (LEO), medium Earth orbit (MEO), or geostationary (GEO) satellite as indicated below:
LEO: typical heights ranging from 250-1,500 kilometers (km), with orbital periods ranging from 90-130 minutes.
MEO: typical heights ranging from 5,000-25,000 km, with orbital periods ranging from 2-14 hours.
GEO: typical height is about 35,786 km, with an orbital period of 24 hours.

A communication satellite typically generates several beams over a given area. The footprint of a beam is usually in an elliptical shape, which has been traditionally considered as a cell. The footprint of a beam is also often referred to as a spotbeam. The footprint of a beam may move over the Earth's surface with the satellite movement or may be Earth fixed with some beam pointing mechanism used by the satellite to compensate for its motion. The size of a spotbeam depends on the system design, which may range from tens of kilometers to a few thousand kilometers.

FIG. 1 shows an example architecture of a satellite network 30. The non-terrestrial network comprises communications satellites 10 communicating with terrestrial antennas or gateways 20, which are then in communication with terrestrial base station(s) 40, e.g., Fifth Generation (5G) NodeB (gNB), eNodeB (eNB), etc. The communications satellite creates the cell in the form of a spotbeam or spotbeam footprint 50 to provide cellular service to one or more wireless devices, e.g., UE 60. In some examples, as shown by the feeder link 70 and service link 80, the communications satellite 10 comprises a bent pipe transponder.

In 3GPP Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality.

In 3GPP Release 15, the first release of the 5G system (5GS) was developed. This is a new generation's radio access technology intended to serve use cases such as enhanced mobile broadband (eMBB), ultra-reliable and low latency communication (URLLC), and massive machine type communications (mMTC). 5G includes the New Radio (NR) access stratum interface and the 5G Core Network (5GC). The NR physical and higher layers are reusing parts of the LTE specification, and to that add needed components when motivated by the new use cases.

### Timing Advance in NTN

5G NR utilizes orthogonal frequency-division multiple access (OFDMA) as the multi-access scheme in the uplink. The transmissions from different UEs in a cell are time-aligned at the gNB to maintain uplink orthogonality. Time alignment is achieved by using different timing advance (TA) values at different UEs to compensate for their different propagation delays. The required TA for a UE is roughly equal to the round-trip delay between the UE and gNB.

For the initial TA, after a UE has synchronized in the downlink and acquired certain system information, the UE transmits a random-access preamble (known as Message 1 (Msg1)) on a physical random-access channel (PRACH). The gNB estimates the uplink timing from the received random-access preamble and responds (Message 2 (Msg2)) with a TA command. This allows the establishment of the initial TA for the UE.

The propagation delays in terrestrial mobile systems are usually less than one millisecond (1 ms). In contrast, the propagation delays in Non-Terrestrial Networks (NTNs) are much longer, ranging from several milliseconds to hundreds of milliseconds depending on the altitudes of the spaceborne or airborne platforms in an NTN. Dealing with such long propagation delays requires modifications of many timing aspects in NR from the physical layer to higher layers, including the TA mechanism.

There are two types of TA mechanisms, which we refer to as large TA and small TA.

With a large TA, each UE has a TA equal to its round-trip time (RTT) and thus fully compensates its RTT. This is illustrated in FIG. 2. Accordingly, gNB Downlink (DL)-Uplink (UL) frame timings are aligned.

With a small TA, each UE has a TA equal to its RTT minus a reference RTT, i.e., differential RTT. For example, the reference RTT can be the minimum RTT of a cell, and thus, the differential RTT of any UE in the cell is always non-negative. The maximum differential RTT depends on the cell size and may range from sub-millisecond to a few milliseconds. With a small TA, the gNB needs to manage a DL-UL frame timing shift on the order of the reference RTT, as illustrated in FIG. 3.

### NR Scheduling Timing Relationship

When the UE is scheduled to receive a Physical Downlink Shared Channel (PDSCH) by a Downlink Control Information (DCI), the DCI indicates the slot offset K0 among other things. The slot allocated for the PDSCH is

$$⌊ n \cdot \frac{{2}^{{μ}_{PDSCH}}}{{2}^{{μ}_{PDCCH}}} ⌋ + {K}_{0} ,$$

where n is the slot with the scheduling DCI, and K0 is based on the numerology of the PDSCH, and μ_{PDSCH} and μ_{PDCCH} are the subcarrier spacing configurations for the PDSCH and Physical Downlink Control Channel (PDCCH), respectively. The value of K0 is in the range of 0, . . . , 32. FIG. 4 provides an illustration of the slot offset K0 when μ_{PDSCH} and μ_{PDCCH} are the same.

When the UE is scheduled to transmit a Physical Uplink Shared Channel (PUSCH) by a DCI, the DCI indicates the slot offset K2 among other things. The slot allocated for the PUSCH is

$$⌊ n \cdot \frac{{2}^{{μ}_{PUSCH}}}{{2}^{{μ}_{PDCCH}}} ⌋ + {K}_{2} ,$$

where n is the slot with the scheduling DCI, and K2 is based on the numerology of the PUSCH, and μ_{PUSCH} and μ_{PDCCH} are the subcarrier spacing configurations for the PUSCH and PDCCH, respectively. The value of K2 is in the range of 0, . . . , 32. FIG. 5 is an illustration of the slot offset K2 when μ_{PUSCH} and μ_{PDCCH} are the same.

There is a special type of PUSCH transmission, i.e., Message 3 (Msg3) transmission, which is scheduled by a Random Access Response (RAR) grant sent in Msg2. With reference to slots for a PUSCH transmission scheduled by a RAR grant, if a UE receives a PDSCH with a RAR message ending in slot n for a corresponding PRACH transmission from the UE, the UE transmits the PUSCH in slot n+K₂+Δ, where Δ may take value from {2, 3, 4, 6}.

The timing for reporting a Hybrid automatic repeat request (HARQ) acknowledgment (ACK) (HARQ-ACK) is determined through K1, as detailed in the sequel. With reference to slots for Physical Uplink Control Channel (PUCCH) transmissions, if the UE detects a DCI format 1_0 or a DCI format 1_1 scheduling a PDSCH reception ending in slot n or if the UE detects a DCI format 1_0 indicating a Semi-Persistent Scheduling (SPS) PDSCH release through a PDCCH reception ending in slot n, the UE provides corresponding HARQ-ACK information in a PUCCH transmission within slot n+K₁, where K1 is a number of slots and is indicated by the PDSCH-to-HARQ-timing-indicator field in the DCI format, if present, or provided by dl-DataToUL-ACK. K₁=0 corresponds to the last slot of the PUCCH transmission that overlaps with the PDSCH reception or with the PDCCH reception in case of a SPS PDSCH release.

For DCI format 1_0, the PDSCH-to-HARQ-timing-indicator field values map to {1, 2, 3, 4, 5, 6, 7, 8}.

For DCI format 1_1, if present, the PDSCH-to-HARQ-timing-indicator field values map to values for a set of number of slots provided by dl-DataToUL-ACK, where the value range of dl-DataToUL-ACK is a sequence with up to 8 elements chosen from 0, . . . , 15. If the UE detects a DCI format 1_1 that does not include a PDSCH-to-HARQ-timing-indicator field and schedules a PDSCH reception or activates a SPS PDSCH reception ending in slot n, the UE provides corresponding HARQ-ACK information in a PUCCH transmission within slot n+K₁ where K1 is provided by dl-DataToUL-ACK.

For a SPS PDSCH reception ending in slot n, the UE transmits the PUCCH in slot n+K₁ where K1 is provided by the PDSCH-to-HARQ-timing-indicator field in DCI format 1_0 or, if present, in DCI format 1_1 activating the SPS PDSCH reception.

FIG. 6 is an illustration of the slot offset K1 when μ_{PDSCH} and μ_{PUCCH} are the same.

Note that the scheduling timing is defined with respect to “logical timing.” In logical timing, the uplink TA is assumed to be zero, as shown in FIGS. 3, 4, and 5. The scheduler needs to take into account appropriate timing constraints due to the minimum UE processing time when indicating timing. This is illustrated in FIG. 7 for a PUSCH scheduled by a PDCCH.

### SUMMARY

Systems and methods for scheduling timing for large cells and long propagation delays are disclosed herein. Embodiments include a method performed by a User Equipment (UE) comprising receiving, from a network node, a cell-specific offset for a scheduling timing and/or a UE-specific offset for the scheduling timing. The method further includes determining the scheduling timing based on the cell-specific offset for the scheduling timing and/or the UE-specific offset for the scheduling timing. In some embodiments, the scheduling timing further comprises a Hybrid Automatic Repeat Request (HARQ) feedback timing, a Physical Uplink Shared Channel (PUSCH) timing, or a RRC Connection Request (Msg3) timing. In some embodiments the method further comprises transmitting a HARQ feedback, a PUSCH, or a Msg3 in accordance with the determined scheduling timing. In this manner, scheduling timing is enhanced to allow for networks with large cells and/or long propagation delays, such as the Non-Terrestrial Network (NTN).

In some embodiments receiving the cell-specific offset for the scheduling timing and/or the UE-specific offset for the scheduling timing comprises receiving both the cell-specific offset for the scheduling timing and the UE-specific offset for the scheduling timing, wherein the UE-specific offset overwrites the cell-specific offset such that determining the scheduling timing comprises determining the scheduling timing based on the UE-specific offset, but not the cell-specific offset.

In some embodiments, receiving the cell-specific offset for the scheduling timing and/or the UE-specific offset for the scheduling timing comprises receiving both the cell-specific offset for the scheduling timing and the UE-specific offset for the scheduling timing, and determining the scheduling timing comprises determining the scheduling timing based on a sum of the cell-specific offset and the UE-specific offset.

In some embodiments, the scheduling timing is a HARQ feedback timing for a particular Downlink Control Information (DCI) format, receiving the cell-specific offset for the scheduling timing and/or the UE-specific offset for the scheduling timing comprises receiving the cell-specific offset for the scheduling timing, the cell-specific offset being a cell-specific offset for the HARQ feedback timing for the particular DCI format, and determining the scheduling timing comprises determining the HARQ feedback timing based on a sum of a Physical Downlink Shared Channel (PDSCH)-to-HARQ feedback timing offset and the cell-specific offset.

In some embodiments, the method further comprises receiving, from the network node, system information that comprises a set of PDSCH-to-HARQ feedback offset values that map to a set of PDSCH-to-HARQ-timing indicator values, and receiving a DCI that schedules a PDSCH, the DCI comprising a PDSCH-to-HARQ-timing-indicator field having one of the set of PDSCH-to-HARQ-timing indicator values to thereby indicate the PDSCH-to-HARQ feedback timing offset.

In some embodiments, determining the HARQ feedback timing based on the sum of the PDSCH-to-HARQ feedback timing offset and the cell-specific offset comprises determining the HARQ feedback timing as slot n+K_(1,offset)+K_1, where n is a slot in which the PDSCH is received, K_(1,offset) is the cell-specific offset, and K_1 is the PDSCH-to-HARQ feedback timing offset.

In some embodiments, receiving the cell-specific offset for the scheduling timing and/or the UE-specific offset for the scheduling timing comprises receiving system information including the cell-specific offset and/or receiving UE-specific RRC signaling including the UE-specific offset.

In some embodiments, the scheduling timing is a HARQ feedback timing for a particular DCI format, receiving the cell-specific offset for the scheduling timing and/or the UE-specific offset for the scheduling timing comprises receiving the cell-specific offset for the scheduling timing and receiving the UE-specific offset for the scheduling timing, the cell-specific offset being a cell-specific offset for the HARQ feedback timing for the particular DCI format and the UE-specific offset being a UE-specific offset for the HARQ feedback timing for the particular DCI format, and determining the scheduling timing comprises determining the HARQ feedback timing based on a sum of a PDSCH-to-HARQ feedback timing offset and the cell-specific offset and/or the UE-specific offset.

In some embodiments, determining the HARQ feedback timing based on the sum of the PDSCH-to-HARQ feedback timing offset and the cell-specific offset comprises determining the HARQ feedback timing as slot n+K_(1,offset)+K_1, where n is a slot in which the PDSCH is received, K_(1,offset) is the cell-specific offset and/or the UE-specific offset, and K_1 is the PDSCH-to-HARQ feedback timing offset.

In some embodiments, the scheduling timing is a PUSCH timing for a PUSCH transmission, receiving the cell-specific offset for the scheduling timing and/or the UE-specific offset for the scheduling timing comprises receiving a cell-specific offset for scheduling PUSCH timing for the particular DCI format and/or receiving a UE-specific offset for scheduling PUSCH timing for the particular DCI format, the cell-specific offset being a cell-specific offset for PUSCH timing and the UE-specific offset being a UE-specific offset for PUSCH timing, and determining the scheduling timing comprises determining the PUSCH timing based on a sum of a Physical Downlink Control Channel (PDCCH)-to-PUSCH timing offset and the cell-specific offset and/or the UE-specific offset.

In some embodiments, determining the PUSCH timing based on a sum of the PDCCH-to-PUSCH timing offset and the cell-specific offset and/or the UE-specific offset comprises determining the slot allocated for the PUSCH transmission as └n·2\hat{ }(μ_PUSCH)/2\hat{ }(μ_PDCCH)┘+K_(2,offset)+K_2, where n is the slot with the scheduling DCI, and K_2 is based on the numerology of PUSCH, and μ_PUSCH and μ_PDCCH are the subcarrier spacing configurations for PUSCH and PDCCH, respectively, and K_(2,offset) is the cell-specific offset for the PUSCH timing and/or the UE-specific offset for the PUSCH timing.

In some embodiments, the scheduling timing is a PUSCH timing for a PUSCH transmission, and receiving the cell-specific offset for the scheduling timing and/or the UE-specific offset for the scheduling timing comprises receiving the cell-specific offset for the scheduling timing, the cell-specific offset being a cell-specific offset for PUSCH timing.

In some embodiments, the scheduling timing is a PUSCH timing for a PUSCH transmission, receiving the cell-specific offset for the scheduling timing and/or the UE-specific offset for the scheduling timing comprises receiving an offset value range of cell-specific offsets for the scheduling timing and receiving a cell-specific offset indicator indicating a cell-specific offset in the offset value range, the cell-specific offset being a cell-specific offset for PUSCH timing, and determining the scheduling timing comprises determining the PUSCH timing based on a sum of a Random Access Request (RAR) Upload (UL) grant-to-PUSCH timing offset and the cell-specific offset.

In some embodiments, determining the PUSCH timing based on the sum of the RAR UL grant-to-PUSCH timing offset and the cell-specific offset comprises determining the slot allocated for PUSCH transmission as n+K_(2,offset)+K_2+Δ, where n is the slot in which the RAR message ends, K_(2,offset) is indicated by cell-specific offset, K2 is indicated in the PUSCH time resource allocation field of RAR UL grant, and Δ is one of 2, 3, 4, and 6.

In some embodiments, receiving the cell-specific offset for the scheduling timing comprises receiving system information comprising the cell-specific offset.

Embodiments of a method performed by a UE are also disclosed herein. The method of the UE comprises obtaining, from a network node, an indication of a set of PDSCH-to-HARQ timing offset values, the set of PDSCH-to-HARQ timing offset values being from an extended range of values that, for DCI format 1_0 has an upper bound that is greater than 8 and, for DCI format 1_1 has an upper bound that is greater than 15, receiving (814), from the network, a DCI message comprising a PDSCH-to-HARQ timing offset indicator that indicates one of the set of PDSCH-to-HARQ timing offset values; and determining (816) a scheduling timing for HARQ feedback for a PDSCH scheduled by the DCI message based on the one of the set of PDSCH-to-HARQ timing offset values indicated by the PDSCH-to-HARQ timing offset indicator. In some embodiments, the method further comprises transmitting a HARQ feedback for the PDSCH in accordance with the determined scheduling timing.

In some embodiments, the DCI message uses DCI format 1_0, and the extended range of values has an upper bound that is greater than 8.

In some embodiments, the DCI message uses DCI format 1_1, and the extended range of values has an upper bound that is greater than 15.

Embodiments of a method performed by a network node are also disclosed herein. The method comprises transmitting, from the network node, a cell-specific offset for a scheduling timing and/or a UE-specific offset for the scheduling timing from a UE to the base station, and receiving a transmission from the UE in accordance with the determined scheduling timing. In some embodiments the scheduling timing comprises a HARQ feedback timing, a PUSCH timing, or a Msg3 timing and the transmission comprises a HARQ feedback, a PUSCH, or a Msg3 from the UE.

Embodiments of a wireless device are also disclosed herein. In one embodiment, a wireless device as disclosed herein is configured to receive (802), from a network node, a cell-specific offset for a scheduling timing and/or a UE-specific offset for the scheduling timing; and determine (804) the scheduling timing based on the cell-specific offset for the scheduling timing and/or the UE-specific offset for the scheduling timing. In some embodiments the scheduling timing comprises a HARQ feedback timing, a PUSCH timing, or a Msg3 timing.

In another embodiment, a wireless device as disclosed herein is configured to obtain (812), from a network node, indication configuration of a set of PDSCH-to-HARQ timing offset values, the set of PDSCH-to-HARQ timing offset values being from an extended range of values that, for DCI format 1_0 has an upper bound that is greater than 8 and, for DCI format 1_1 has an upper bound that is greater than 15, receive (814), from the network node, a DCI message comprising a PDSCH-to-HARQ timing offset indicator that indicates one of the set of PDSCH-to-HARQ timing offset values, and determine (816) a scheduling timing for HARQ feedback for a PDSCH scheduled by the DCI message based on the one of the set of PDSCH-to-HARQ timing offset values indicated by the PDSCH-to-HARQ timing offset indicator.

Embodiments of a network node are also disclosed. In some embodiments disclosed herein, a network node is configured to transmit a cell-specific offset for a scheduling timing and/or a UE-specific offset for the scheduling timing from a UE to the network node and receive a transmission in accordance with the determined scheduling timing. In some embodiments the scheduling timing further comprises a HARQ feedback timing, a PUSCH timing, or a Msg3 timing and the transmission further comprises a HARQ feedback, a PUSCH, or a Msg3.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example architecture of a non-terrestrial network.

FIG. 2 is an illustration of a large Timing Advance (TA) compensating full Round Trip Time (RTT).

FIG. 3 is an illustration of a small TA compensating differential RTT.

FIG. 4 is an illustration of the slot offset K0 when μ_PDSCH and μ_PDCCH are the same.

FIG. 5 is an illustration of the slot offset K2 when μ_PUSCH and μ_PDCCH are the same.

FIG. 6 is an illustration of the slot offset K1 when μ_PDSCH and μ_PUCCH are the same.

FIG. 7 is an illustration of Physical Downlink Control Channel (PDCCH) to Physical Uplink Shared Channel (PUSCH) scheduling timing.

FIG. 8 is a diagram of a call flow between a network node and a wireless device in accordance with some embodiments.

FIG. 9 is a diagram of a call flow between a network node and a wireless device in accordance with some embodiments.

FIG. 10 depicts a wireless network in accordance with some embodiments.

FIG. 11 depicts a user equipment (UE) in accordance with some embodiments.

FIG. 12 depicts a virtualization environment in accordance with some embodiments.

FIG. 13 depicts a network connected via an intermediate network to a host computer in accordance with some embodiments.

FIG. 14 depicts a host computer communicating via a base station with a UE over a partially wireless connection in accordance with some embodiments.

FIG. 15 depicts a flowchart of a method implemented in a communication system including a host computer, a base station, and a UE in accordance with some embodiments.

FIG. 16 depicts a flowchart of a method implemented in a communication system including a host computer, a base station, and a UE in accordance with some embodiments.

FIG. 17 depicts a flowchart of a method implemented in a communication system including a host computer, a base station, and a UE in accordance with some embodiments.

FIG. 18 depicts a flowchart of a method implemented in a communication system including a host computer, a base station, and a UE in accordance with some embodiments.

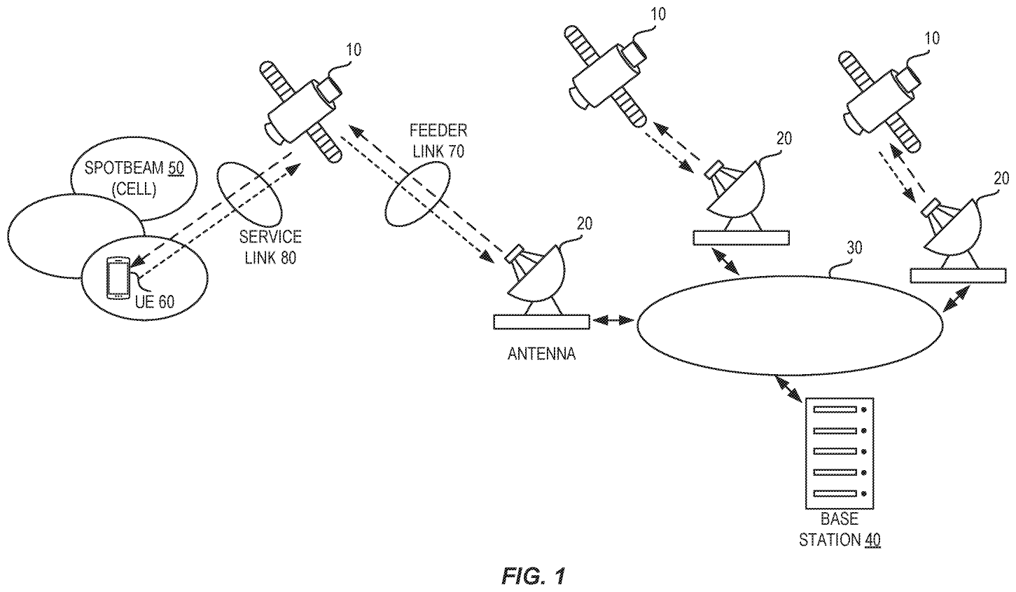

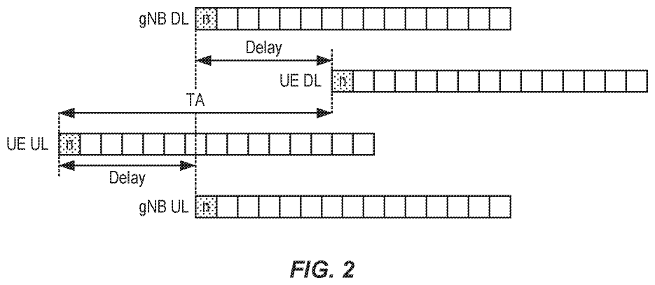

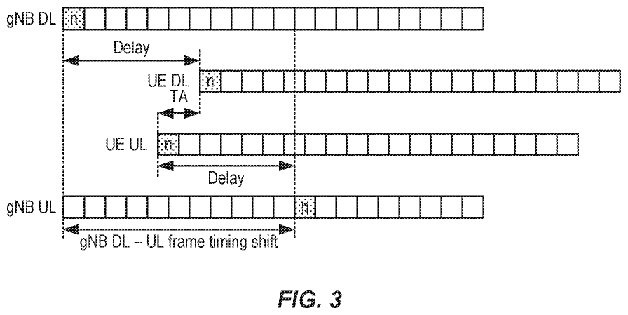

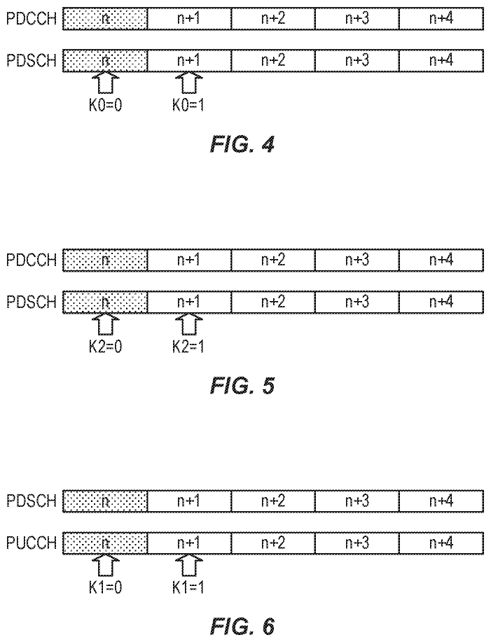

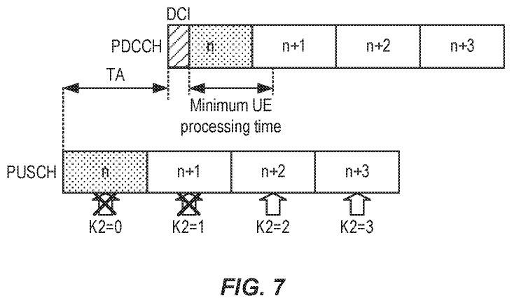

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenges. With the existing New Radio (NR) scheduling solutions, the usable scheduling offset ranges are reduced (e.g., when a small Timing Advance (TA) is used) or even empty (e.g., when a large TA is used). Table 1 gives example usage scheduling offset ranges. It can be seen that even using a small TA, for K₁ with 120 kilohertz (kHz) subcarrier spacing, there are no usable K₁ values for Downlink Control Information DCI 1_0. This would make this case broken because DCI 1_0 is the fallback DCI format and is critical for NR operation. Additionally, when using a large TA, the usable scheduling offset ranges for K₁ and K₂ are empty. In this case, the system cannot function.

TABLE 1
Example usable scheduling offset ranges

| | | | | | Usable | Usable | |
|---|---|---|---|---|---|---|---|
| | | Max TA | | Usable | K1 range | K1 range | Usage |
| | | in the | | K0 range | from | from | K2 range |
| | | unit of | | from | 1, . . . , 8 | 0, . . . , 15 | from |
| TA scheme | Numerology | slot | | 0, . . . , 32 | (DCI 1_0) | (DCI 1_1) | 0, . . . , 32 |
| TA compensating | 15 kHz | 1.6 | slots | No impact | 1, . . . , 8 | 1, . . . . 15 | 1, . . . , 32 |
| for differential | 30 kHz | 3.2 | slots | No impact | 3, . . . , 8 | 3, . . . , 15 | 3, . . . , 32 |
| Round Trip Time | 60 kHz | 6.4 | slots | No impact | 7, 8 | 6, . . . , 15 | 6, . . . , 32 |
| (RTT) up to 1.6 | 120 kHz | 12.8 | slots | No impact | None | 12, . . . , 15 | 12, . . . , 32 |
| ms (small TA) | | | | | | | |
| TA compensating | 15 kHz | 541.46 | slots | No impact | None | None | None |
| for full RTT | 30 kHz | 1082.92 | slots | No impact | None | None | None |
| up to 541.46 | 60 kHz | 2165.84 | slots | No impact | None | None | None |
| ms (large TA) | 120 kHz | 4331.68 | slots | No impact | None | None | None |

Certain aspects of the present disclosure and their embodiments may provide solutions to these or other challenges. NR scheduling timing is enhanced with the introduction of cell specific scheduling offsets and User Equipment (UE) specific scheduling offsets and extensions of the existing value ranges for scheduling. The enhancements take into account the different characteristics of different DCI formats and Random Access Request (RAR) grant.

A set of backward compatible methods enhances NR scheduling timing so that NR can work in the scenarios with large cells and/or long propagation delays, such as the Non-Terrestrial Network (NTN).

The essence of the solution is the determination of NR scheduling time with the newly introduced cell specific scheduling offsets and UE specific scheduling offsets and extensions of the existing value ranges for scheduling, by taking into account the different characteristics of different DCI formats and RAR grant.

Certain embodiments may provide one or more of the following technical advantages. The main advantages of the proposed solution may include enhancing NR scheduling timing to make NR work in the scenarios with large cells and/or long propagation delays, such as the NTN, and these enhancements fit under the existing NR scheduling framework and are backward compatible. Note, however, that an NTN is not limited to a satellite-based network, but rather may include other types of non-terrestrial, or aerial, network nodes, such as balloon-based or drone-based network nodes.

### Hybrid Automatic Response Request (HARQ)-Acknowledgment (ACK) Timing with DCI Format 1_0

The K₁ value range can be configured in a system information block (SIB), for example, SIB1. The network can configure 8 values chosen from for example 0, . . . , 31. The Physical Downlink Shared Channel (PDSCH)-to-HARQ-timing-indicator field values in DCI format 1_0 map to the configured 8 values. If the network does not configure the K₁ value range in the SIB, the PDSCH-to-HARQ-timing-indicator field values in DCI format 1_0 map to {1, 2, 3, 4, 5, 6, 7, 8}. In this regard, the UE obtains, from a network node, an indication of chosen values from an extended range of values, where the extended range of values, for DCI 1_0, has an upper bound that is greater than 8 for scheduling a HARQ feedback timing (e.g., HARQ-ACK). PDSCH-to-HARQ-timing-indicator field values provided in the DCI format 1_0 map to corresponding PDSCH-to-HARQ feedback timing offsets (e.g., K₁) in the extended range of values.

Additionally, an offset, denoted as dl-DataToUL-ACK-Offset-Common, can be configured in the system information block (SIB). The value range for the offset can be made dependent on Low Earth Orbit (LEO)/Medium Earth Orbit (MEO)/Geo-stationary Orbit (GEO), or NTN propagation delay, or numerology. If the network does not configure the dl-DataToUL-ACK-Offset-Common in the system information block, the UE assumes that the dl-DataToUL-ACK-Offset-Common is zero.

With reference to slots for PUCCH transmissions, if the UE detects a DCI format 1_0 scheduling a PDSCH reception ending in slot n or if the UE detects a DCI format 1_0 indicating a Semi-Persistent Scheduling (SPS) PDSCH activation/release through a Physical Downlink Control Channel (PDCCH) reception ending in slot n, the UE provides corresponding HARQ-ACK information in a Physical Uplink Control Channel (PUCCH) transmission within slot n+K_{1,offset}+K₁, where K_{1,offset} is indicated by dl-DataToUL-ACK-Offset-Common and K₁ is a number of slots indicated by the PDSCH-to-HARQ-timing-indicator field in the DCI format 1_0. In other words, the UE receives, from a network node, an offset that is common to all the UEs in the cell (“cell-specific”) for a HARQ feedback timing for the DCI format 1_0. The UE determines a HARQ feedback timing based on the cell-specific offset. In one example, the UE determines the HARQ feedback timing based on a sum of a PDSCH-to-HARQ feedback timing offset and the cell-specific offset. The UE transmits a HARQ feedback in accordance with the determined HARQ feedback timing.

### HARQ-ACQ Timing with DCI Format 1_1

The K₁ value range, 0, . . . , 15, is extended for configuration in UE specific Radio Resource Control (RRC) signaling. The extended value range can be, for example, 0, . . . , 31. The network can configure up to 8 values chosen from the extended range. The PDSCH-to-HARQ-timing-indicator field values in DCI format 1_1 map to the configured values. In this regard, the UE obtains an indication of chosen values from an extended range of values 0 . . . 31 for scheduling a HARQ feedback timing. PDSCH-to-HARQ-timing-indicator field values provided in the DCI format 1_1 map to corresponding PDSCH-to-HARQ feedback timing offsets (e.g., K1) in the extended range of values, where the extended range of values, for DCI 1_1, has an upper bound that is greater than 15 for scheduling a HARQ feedback timing (e.g., HARQ-ACK).

The UE may receive the offset denoted as dl-DataToUL-ACK-Offset-Common that can be configured in the SIB. Additionally, an offset, denoted as dl-DataToUL-ACK-Offset-Specific, can be configured in the UE specific RRC signaling. The value range for the offset can be made dependent on LEO/MEO/GEO, or NTN propagation delay, or numerology. If the network does not configure the dl-DataToUL-ACK-Offset-Specific in the UE specific RRC signaling, the UE assumes that the dl-DataToUL-ACK-Offset-Specific is zero.

With reference to slots for PUCCH transmissions, if the UE detects a DCI format 1_1 scheduling a PDSCH reception ending in slot n or if the UE detects a DCI format 1_1 indicating a SPS PDSCH activation/release through a PDCCH reception ending in slot n, the UE provides corresponding HARQ-ACK information in a PUCCH transmission within slot n+K_{1,offset}+K₁, where K_{1,offset} is indicated by dl-DataToUL-ACK-Offset-Common and/or by dl-DataToUL-ACK-Offset-Specific, and K1 is a number of slots indicated by the PDSCH-to-HARQ-timing-indicator field in the DCI format 1_1.

In one embodiment, dl-DataToUL-ACK-Offset-Specific overwrites dl-DataToUL-ACK-Offset-Common for use in DCI format 1_1. In this case, K_{1,offset} is equal to dl-DataToUL-ACK-Offset-Specific. In this example, the UE determines the HARQ feedback timing offset based on the PDSCH-to-HARQ feedback timing offsets and the UE-specific offset (dl-DataToUL-ACK-Offset-Specific), but not the cell-specific offset (dl-DataToUL-ACK-Offset-Common).

In another embodiment, dl-DataToUL-ACK-Offset-Specific is an additional offset relative to dl-DataToUL-ACK-Offset-Common for use in DCI format 1_1. In this case, K_{1,offset} is equal to dl-DataToUL-ACK-Offset-Common+dl-DataToUL-ACK-Offset-Specific.

Here, for example, the UE receives, from a network node, the cell-specific offset for a HARQ feedback timing for the DCI format 1_1. The UE also receives, in RRC signaling from a network node, another offset specific to the UE (“UE-specific”) for HARQ feedback timing for the DCI format 1_1. The UE determines HARQ feedback timing based on the PDSCH-to-HARQ feedback timing offsets and either the cell-specific offset or a sum of the cell-specific offset and the UE-specific offset. The UE transmits a HARQ feedback in accordance with the determined HARQ feedback timing.

### PDCCH to PUSCH Timing

The K₂ value range, 0, . . . , 32, can be extended to, for example, 0, . . . , 63. The K₂ is a PDCCH-to-PUSCH timing offset used for setting a PUSCH timing for a PUSCH transmission. An offset, denoted as dl-DCIToUL-Data-Offset-Common, can be configured in a SIB, for example, SIB1. That is, the UE receives a cell-specific offset for scheduling PUSCH timing for a particular DCI format. Additionally, an offset, denoted as dl-DCIToUL-Data-Offset-Specific, can be configured in the UE specific RRC signaling. The dl-DCIToUL-Data-Offset-Specific is a UE-specific offset for PUSCH timing for the DCI format. The value range for the offsets can be made dependent on LEO/MEO/GEO, or NTN propagation delay, or numerology. If the network does not configure the dl-DCIToUL-Data-Offset-Common in the SIB (resp. dl-DCIToUL-Data-Offset-Specific in the UE specific RRC signaling), the UE assumes that the dl-DCIToUL-Data-Offset-Common (resp. dl-DCIToUL-Data-Offset-Specific) is zero.

When the UE is scheduled to transmit a PUSCH by a DCI, the DCI indicates the slot offset K2 among other things. The slot allocated for the PUSCH is

$$⌊ n \cdot \frac{{2}^{{μ}_{PUSCH}}}{{2}^{{μ}_{PDCCH}}} ⌋ + {K}_{2 , offset} +$$

K₂, where n is the slot with the scheduling DCI, and K2 is based on the numerology of the PUSCH, and μ_{PUSCH} and μ_{PDCCH} are the subcarrier spacing configurations for PUSCH and PDCCH, respectively, and K_{2,offset} is indicated by dl-DCIToUL-Data-Offset-Common and/or by dl-DCIToUL-Data-Offset-Specific.

For DCI format 0_0, K_{2,offset} is equal to dl-DCIToUL-Data-Offset-Common.

For DCI format 0_1, in one embodiment, dl-DCIToUL-Data-Offset-Specific overwrites dl-DCIToUL-Data-Offset-Common for use in DCI format 0_1. In this case, K_{2,offset} is equal to dl-DCIToUL-Data-Offset-Specific. In another embodiment, dl-DCIToUL-Data-Offset-Specific is an additional offset relative to dl-DCIToUL-Data-Offset-Common for use in DCI format 0_1. In this case, K_{2,offset} is equal to dl-DCIToUL-Data-Offset-Common+dl-DCIToUL-Data-Offset-Specific. The UE determines PUSCH timing based on the PDSCH-to-PUSCH timing offset and one of the cell-specific offset, the UE-specific offset, or a sum of the cell-specific offset and the UE-specific offset. The UE transmits a PUSCH in accordance with the determined PUSCH timing.

### RAR Grant to Msg3 Timing

With reference to slots for a PUSCH transmission scheduled by a RAR UL grant, if a UE receives a PDSCH with a RAR message ending in slot n for a corresponding PRACH transmission from the UE, the UE transmits the PUSCH in slot n+K_{2,offset}+K₂+Δ, where K_{2,offset} is indicated by dl-RARToUL-Data-Offset, K₂ is indicated in the PUSCH time resource allocation field of RAR UL grant, and Δ may take a value from {2, 3, 4, 6}. Here, the K2 is a RAR UL grant-to-PUSCH timing offset used for determining a PUSCH timing for a PUSCH transmission (e.g., a Msg3 timing for a Msg3 transmission).

In one embodiment, an offset, denoted as dl-RARToUL-Data-Offset, can be configured in a SIB, for example, SIB1. In another embodiment, a value range of dl-RARToUL-Data-Offset is configured in the SIB. A field of the RAR UL grant indicates the specific value of dl-RARToUL-Data-Offset. The value range of dl-RARToUL-Data-Offset can be made dependent on LEO/MEO/GEO, or NTN propagation delay, or numerology. Here, the UE receives a cell-specific offset or a cell-specific value range. A cell-specific offset may be determined from the cell-specific value range.

If the network does not signal dl-RARToUL-Data-Offset, the UE assumes that the dl-RARToUL-Data-Offset is zero. The UE determines PUSCH timing based on the RAR UL grant-to-PUSCH timing offset and either the cell-specific offset, the UE-specific offset, or one of the cell-specific offsets in the cell-specific offset value range. The UE transmits a PUSCH in accordance with the determined PUSCH timing.

### Multi-Layer Offsets

The previous description of the usage of each offset value assumes that there is only one value configured and used for the corresponding offset.

In this embodiment, multiple values are configured for an offset type (such as dl-DataToUL-ACK-Offset-Common, dl-DataToUL-ACK-Offset-Specific, dl-DCIToUL-Data-Offset-Common, dl-DCIToUL-Data-Offset-Specific, or dl-RARToUL-Data-Offset). The network further indicates in a separate message which of the configured values is applied for the offset.

In one example, the separate message is a DCI such as
Reserved bit(s) in DCI format 1_0 scrambled by Random Access-Radio Network Temporary Identifier (RA-RNTI)
Reserved bit(s) in DCI format 0_0 scrambled by Temporary Cell—Radio Network Temporary Identifier (TC-RNTI)
A group common DCI
A new DCI with optionally a new RNTI

In another example, a field in Message 2 (i.e., RAR) is used to indicate which of the configured offset values should be applied.

In another example, a Medium Access Control (MAC) Control Element (CE) command is used to indicate which of the configured offset values should be applied.

In another example, an RRC message is used to indicate which of the configured offset values should be applied.

### ADDITIONAL DESCRIPTION

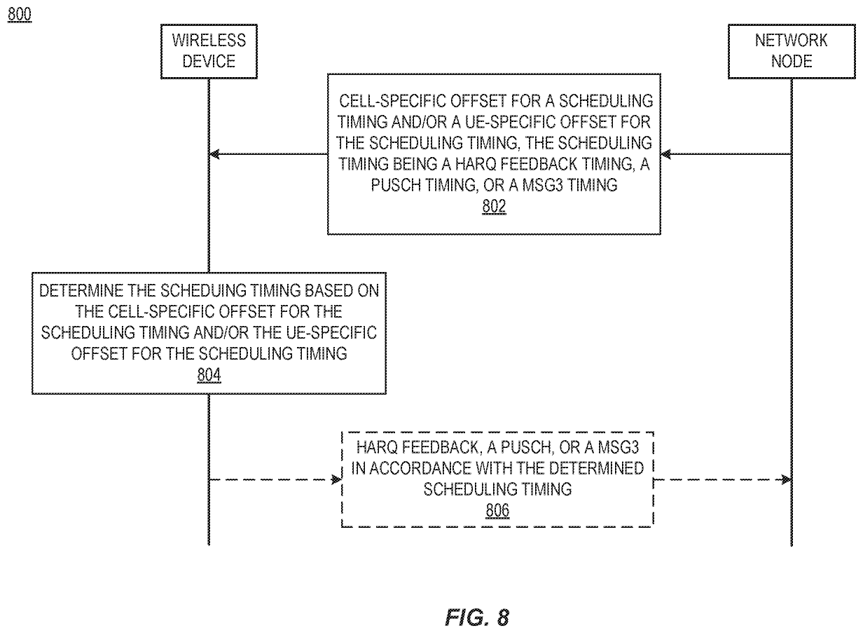

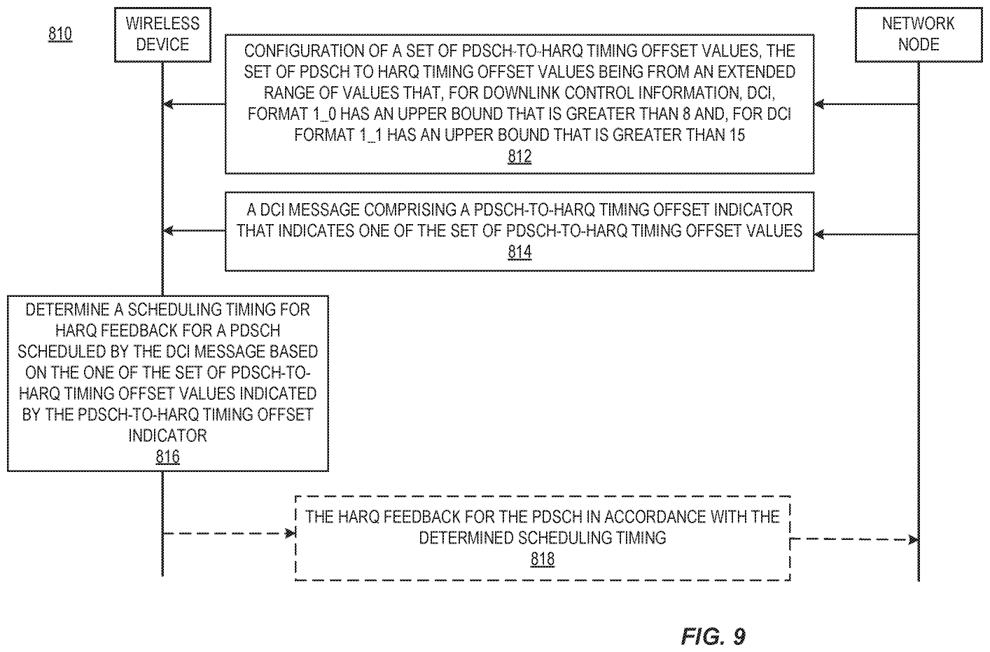

FIGS. 8 and 9 illustrate diagrams of call flows between a network node and a wireless device according to some of these disclosed embodiments. Embodiments of the method include devices configured to perform the enumerated operations. Other embodiments include computer-readable storage devices having instructions stored thereon, which, when executed by a processing device, cause the processing device to perform corresponding operations.

FIG. 8 illustrates diagrams of a call flow 800 between a network node and a wireless device including: the network node transmitting and the wireless device receiving (802), from the network node, a cell-specific offset for a scheduling timing and/or a UE-specific offset for the scheduling timing, the scheduling timing being a HARQ feedback timing, a PUSCH timing, or a Msg3 timing, and the wireless device determining (804) the scheduling timing based on the cell-specific offset for the scheduling timing and/or the UE-specific offset for the scheduling timing. The call flow 800 of FIG. 8 also optionally comprises transmitting (806), from the wireless device to the network node a HARQ feedback, a PUSCH, or a Msg3 in accordance with the determined scheduling timing.

FIG. 9 illustrates a call flow 810, including: a wireless device obtaining (812), from a network node, a configuration of a set of PDSCH-to-HARQ timing offset values, the set of PDSCH to HARQ timing offset values being from an extended range of values that, for DCI format 1_0 has an upper bound that is greater than 8 and, for DCI format 1_1 has an upper bound that is greater than 15, the wireless device receiving (814), from the network node, a DCI message comprising a PDSCH-to-HARQ timing offset indicator that indicates one of the set of PDSCH-to-HARQ timing offset values, and the wireless device determining (816) a scheduling timing for HARQ feedback for a PDSCH scheduled by the DCI message based on the one of the set of PDSCH-to-HARQ timing offset values indicated by the PDSCH-to-HARQ timing offset indicator. The call flow 810 of FIG. 9 also optionally comprises the network node transmitting (818) and the network node receiving, the HARQ feedback for the PDSCH in accordance with the determined scheduling timing.

Additional methods may be performed by a network node, such as a base station and may include operations of: transmitting, from the base station in a non-terrestrial network (NTN), a configuration parameter that indicates of a timing shift to use when communicating with the NTN; and receiving an uplink transmission that uses a time shift in the uplink frame timing, wherein the time shift is based on the configuration parameter.

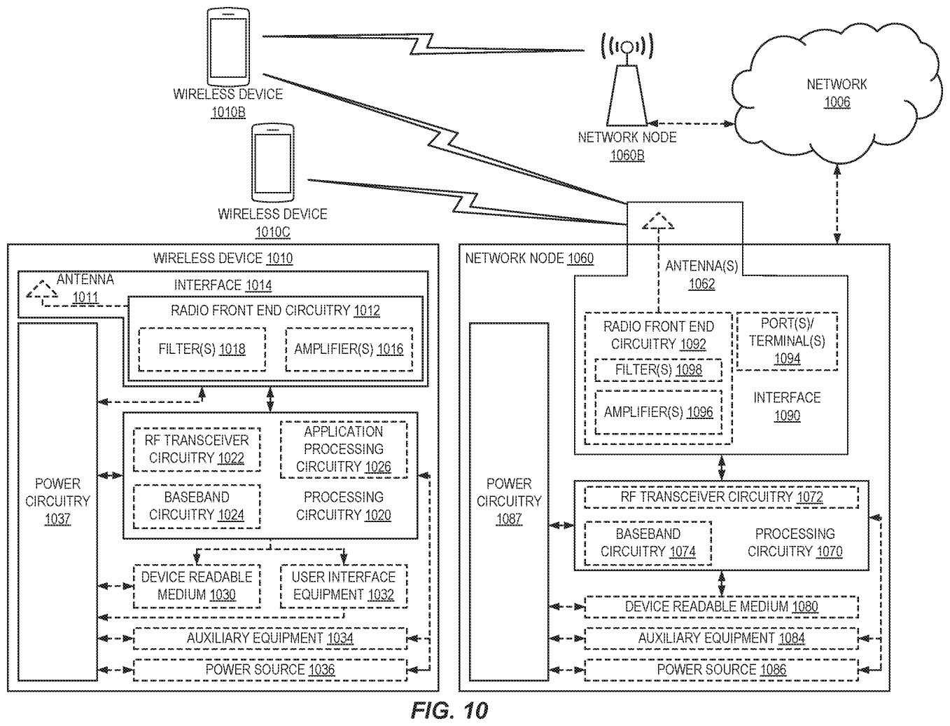

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 1006, network nodes 1060 and 1060B, and wireless devices 1010, 1010B, and 1010C. At least one of the wireless devices 1010, 1010B, and 1010C is configured to perform the call flow 800 of FIG. 8 and the call flow 810 of FIG. 9. In addition, at least one of the wireless devices 1010, 1010B, and 1010C is configured to determine a scheduling timing as described herein, where the scheduling timing is one of a HARQ feedback timing, a PUSCH timing, or a Msg3 timing.

In practice, a wireless network may further include any additional elements suitable to support communication between wireless devices or between a wireless device and another communication device, such as a landline telephone, a service provider, or any other network node or end device. Of the illustrated components, network node 1060 and wireless device 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave, and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and wireless device 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged, and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit (CPU), digital signal processor (DSP), application-specific integrated circuit (ASIC), field programmable gate array (FPGA), or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB, or other such network device may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signaling and/or data between network node 1060, network 1006, and/or wireless devices 1010. As illustrated, interface 1090 comprises port(s)/terminal(s) 1094 to send and receive data, for example, to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or wireless devices via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector, or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data, and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 10 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device refers to a device capable, configured, arranged, and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example, by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another WD and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036, and power circuitry 1037. Wireless device 1010 may include multiple sets of one or more of the illustrated components for different wireless technologies supported by wireless device 1010, such as, for example, GSM, WCDMA, LTE, NR, WiFi, WiMAX, or Bluetooth wireless technologies, just to mention a few. These wireless technologies may be integrated into the same or different chips or set of chips as other components within wireless device 1010.

Antenna 1011 may include one or more antennas or antenna arrays, configured to send and/or receive wireless signals, and is connected to interface 1014. In certain alternative embodiments, antenna 1011 may be separate from wireless device 1010 and be connectable to wireless device 1010 through an interface or port. Antenna 1011, interface 1014, and/or processing circuitry 1020 may be configured to perform any receiving or transmitting operations described herein as being performed by a wireless device. Any information, data, and/or signals may be received from a network node and/or another wireless device. In some embodiments, radio front end circuitry and/or antenna 1011 may be considered an interface.

As illustrated, interface 1014 comprises radio front end circuitry 1012 and antenna 1011. Radio front end circuitry 1012 comprises one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, wireless device 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or wireless devices via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other wireless device 1010 components, such as device readable medium 1030, wireless device 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of wireless device 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a wireless device may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner In any of those particular embodiments, whether executing instructions stored on a device readable storage medium or not, processing circuitry 1020 can be configured to perform the described functionality. The benefits provided by such functionality are not limited to processing circuitry 1020 alone or to other components of wireless device 1010, but are enjoyed by wireless device 1010 as a whole, and/or by end users and the wireless network generally.

Processing circuitry 1020 may be configured to perform any determining, calculating, or similar operations (e.g., certain obtaining operations) described herein as being performed by a wireless device. These operations, as performed by processing circuitry 1020, may include processing information obtained by processing circuitry 1020 by, for example, converting the obtained information into other information, comparing the obtained information or converted information to information stored by wireless device 1010, and/or performing one or more operations based on the obtained information or converted information, and as a result of said processing making a determination.

Device readable medium 1030 may be operable to store a computer program, software, an application including one or more of logic, rules, code, tables, etc., and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with wireless device 1010. Such interaction may be of many forms, such as visual, audial, tactile, etc. User interface equipment 1032 may be operable to produce output to the user and to allow the user to provide input to wireless device 1010. The type of interaction may vary depending on the type of user interface equipment 1032 installed in wireless device 1010. For example, if wireless device 1010 is a smart phone, the interaction may be via a touch screen; if wireless device 1010 is a smart meter, the interaction may be through a screen that provides usage (e.g., the number of gallons used) or a speaker that provides an audible alert (e.g., if smoke is detected). User interface equipment 1032 may include input interfaces, devices, and circuits, and output interfaces, devices, and circuits. User interface equipment 1032 is configured to allow input of information into wireless device 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, wireless device 1010 may communicate with end users and/or the wireless network, and allow them to benefit from the functionality described herein.

Auxiliary equipment 1034 is operable to provide more specific functionality which may not be generally performed by wireless devices. This may comprise specialized sensors for doing measurements for various purposes, interfaces for additional types of communication such as wired communications, etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices, or power cells, may also be used. Wireless device 1010 may further comprise power circuitry 1037 for delivering power from power source 1036 to the various parts of wireless device 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case wireless device 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of wireless device 1010 to which power is supplied.

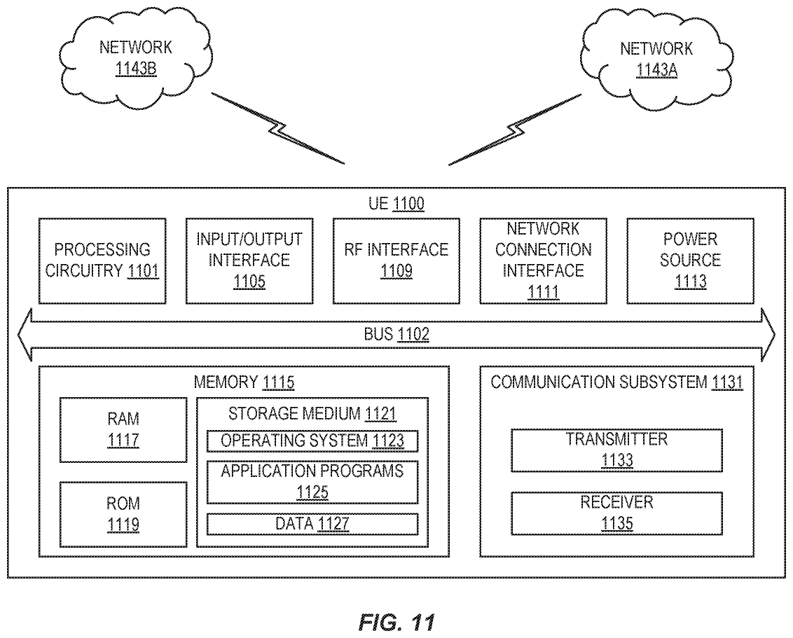

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3^{rd} Generation Partnership Project (3GPP), including a NB-IoT UE, a machine type communication (MTC) UE, and/or an enhanced MTC (eMTC) UE. UE 1100, as illustrated in FIG. 11, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the terms wireless device and UE may be used interchangeably. Accordingly, although FIG. 11 is a UE, the components discussed herein are equally applicable to a wireless device, and vice-versa.

In FIG. 11, UE 1100 includes processing circuitry 1101 that is operatively coupled to input/output interface 1105, RF interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 1101 may include two CPUs. Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1109 may be configured to provide a communication interface to RF components such as a transmitter, a receiver, and an antenna. Network connection interface 1111 may be configured to provide a communication interface to network 1143A. Network 1143A may encompass wired and/or wireless networks such as a local-area network (LAN), a wide-area network (WAN), a computer network, a wireless network, a telecommunications network, another like network, or any combination thereof. For example, network 1143A may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine, or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 11, processing circuitry 1101 may be configured to communicate with network 1143B using communication subsystem 1131. Network 1143A and network 1143B may be the same network or networks or different network or networks. Communication subsystem 1131 may be configured to include one or more transceivers used to communicate with network 1143B. For example, communication subsystem 1131 may be configured to include one or more transceivers used to communicate with one or more remote transceivers of another device capable of wireless communication such as another wireless device, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143B may encompass wired and/or wireless networks such as a local-area network (LAN), a wide-area network (WAN), a computer network, a wireless network, a telecommunications network, another like network or any combination thereof. For example, network 1143B may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

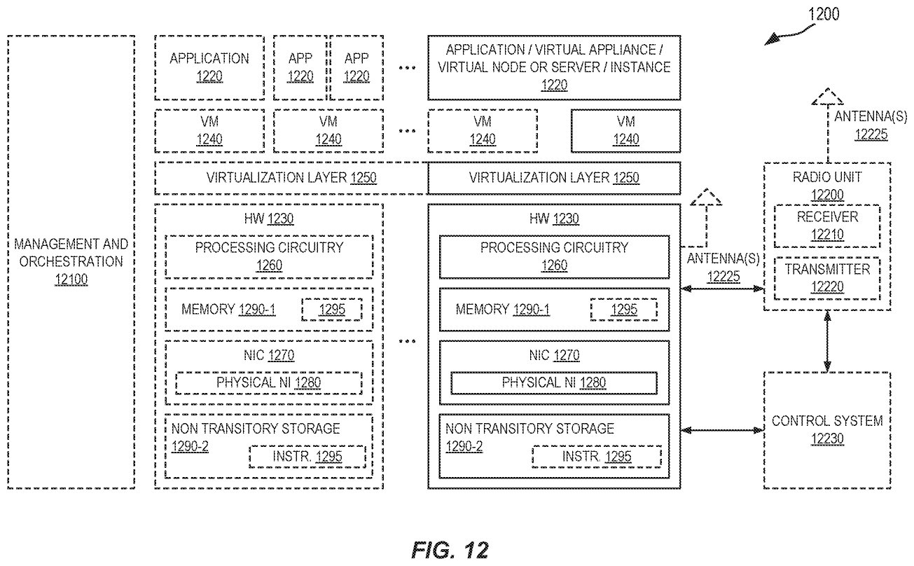

FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines, or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated ASICs, or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240, as well as software allowing it to execute functions, features and/or benefits described in relation with some embodiments described herein.

Virtual machines 1240 comprise virtual processing, virtual memory, virtual networking or interface, and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 12, hardware 1230 may be a standalone network node with generic or specific components. Hardware 1230 may comprise antenna 12225 and may implement some functions via virtualization. Alternatively, hardware 1230 may be part of a larger cluster of hardware (e.g., such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network element (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signaling can be effected with the use of control system 12230 which may alternatively be used for communication between the hardware nodes 1230 and radio units 12200.

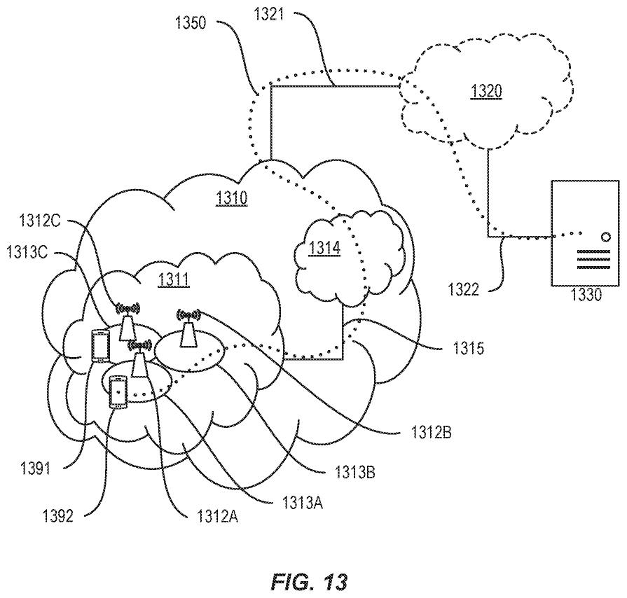

With reference to FIG. 13, in accordance with an embodiment, a communication system includes telecommunication network 1310, such as a 3GPP-type cellular network, which comprises access network 1311, such as a radio access network, and core network 1314. Access network 1311 comprises a plurality of base stations 1312A, 1312B, 1312C, such as NBs, eNBs, gNBs or other types of wireless access points, each defining a corresponding coverage area 1313A, 1313B, 1313C. Each base station 1312A, 1312B, 1312C is connectable to core network 1314 over a wired or wireless connection 1315. A first UE 1391 located in coverage area 1313C is configured to wirelessly connect to, or be paged by, the corresponding base station 1312C. A second UE 1392 in coverage area 1313A is wirelessly connectable to the corresponding base station 1312A. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server, or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private, or hosted network; intermediate network 1320, if any, may be a backbone network or the Internet; in particular, intermediate network 1320 may comprise two or more sub-networks (not shown).

The communication system of FIG. 13 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320, and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

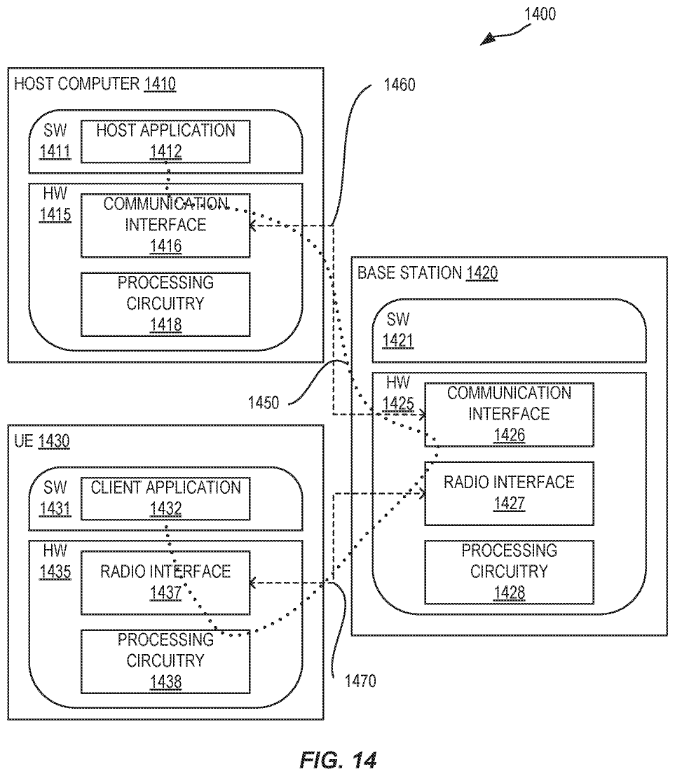

Example implementations, in accordance with an embodiment, of the UE, base station, and host computer discussed in the preceding paragraphs will now be described with reference to FIG. 14. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, ASICs, FPGAs, or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 14) served by base station 1420. Communication interface 1426 may be configured to facilitate connection 1460 to host computer 1410. Connection 1460 may be direct or it may pass through a core network (not shown in FIG. 14) of the telecommunication system and/or through one or more intermediate networks outside the telecommunication system. In the embodiment shown, hardware 1425 of base station 1420 further includes processing circuitry 1428, which may comprise one or more programmable processors, ASICs, FPGAs, or combinations of these (not shown) adapted to execute instructions. Base station 1420 further has software 1421 stored internally or accessible via an external connection.

Communication system 1400 further includes UE 1430 already referenced. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, ASICs, FPGAs, or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 14 may be similar or identical to host computer 1330, one of base stations 1312A, 1312B, 1312C and one of UEs 1391, 1392 of FIG. 13, respectively. This is to say, the inner workings of these entities may be as shown in FIG. 14 and independently, the surrounding network topology may be that of FIG. 13.

In FIG. 14, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further make decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency and power consumption of wireless devices and decrease overhead in NTNs and thereby provide benefits such as extended battery life and improved latency and data rates.

A measurement procedure may be provided for the purpose of monitoring data rate, latency, and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In some embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing, etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency, and the like. The measurements may be implemented in that software 1411 and 1431 causes messages to be transmitted, in particular empty or ‘dummy’ messages, using OTT connection 1450 while it monitors propagation times, errors, etc.

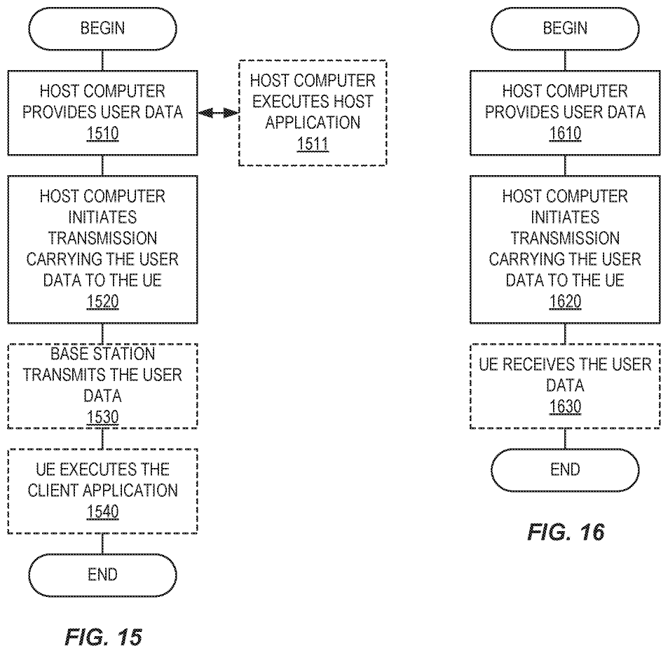

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

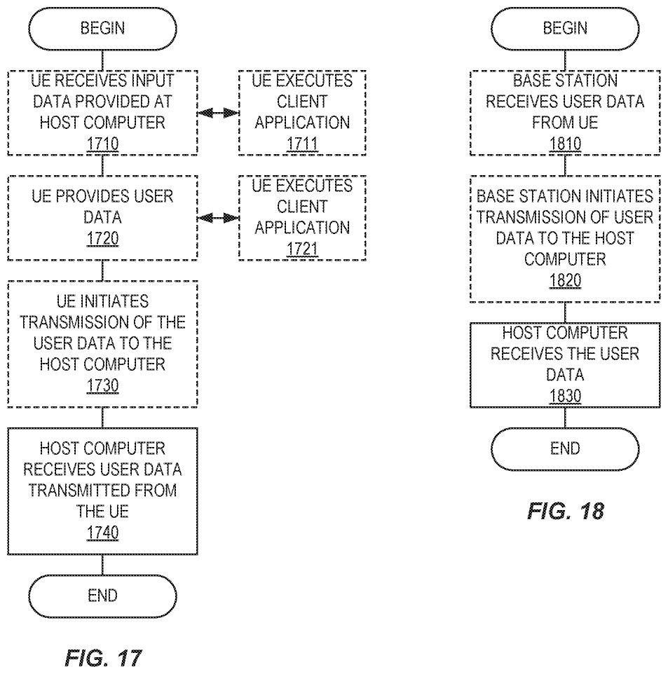

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, such as those that are described herein.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

While not being limited thereto, some example embodiments of the present disclosure are provided below.

### GROUP A EMBODIMENTS

Embodiment 1: A method performed by a wireless device for performing an uplink transmission, the method comprising:
receiving, from a non-terrestrial network (NTN), a configuration parameter that indicates of a timing shift to use when communicating with the NTN;
performing a time shift of an uplink frame timing with respect to a downlink frame time wherein the timing shift is selected based on the parameter; and
performing an uplink transmission using the time shift of the uplink frame timing.

Embodiment 2: The method of the preceding embodiment, wherein receiving the configuration parameter comprises receiving a PDSCH with a RAR message.

Embodiment 3: The method of the preceding embodiment, wherein the RAR message includes an indication of the time shift.

Embodiment 4: The method of the preceding embodiments, wherein receiving the configuration parameter comprises receiving a SIB having the parameter.

Embodiment 5: The method of any of the preceding embodiments wherein a value range of the time shift is dependent on an orbital height of a satellite in the NT or on a numerology.

Embodiment 6: A method performed by a wireless device for performing an uplink transmission, the method comprising:
receiving, from a non-terrestrial network (NTN), a first configuration parameter that indicates of a timing shift to use when communicating with the NTN;
receiving, from a non-terrestrial network (NTN), a second configuration parameter that indicates of a timing shift to use when communicating with the NTN;
performing a time shift of an uplink frame timing with respect to a downlink frame time wherein the timing shift is selected based on at least one of the first parameter and the second parameter; and
performing an uplink transmission using the time shift of the uplink frame timing.

Embodiment 7: The method of the preceding embodiment, further comprising receiving a message, separate from the first and second configuration parameters, that indicates whether to utilize the first configuration parameter or the second configuration parameter.

Embodiment 8: The method of the preceding embodiment, wherein the message is a downlink control information message.

Embodiment 9: The method of the preceding embodiment, wherein the message is a reserved bit or bits in DCI format 1_0 scrambled by RA-RNTI or DCI format 0_0 scrambled by TC-RNTI.

Embodiment 10: The method of the preceding embodiments, wherein the message is a common group DCI or a new DCI with an new RNTI.

Embodiment 11: The method of any of the preceding embodiments, wherein the message is a field in Message 2, or a MAC CE command, or an RRC message.

Embodiment 12: The method of any of the previous embodiments, further comprising providing user data and forwarding the user data to a host computer via the transmission to the base station.

### GROUP B EMBODIMENTS

Embodiment 13: A method performed by a base station, the method comprising:
transmitting, from the base station in a non-terrestrial network (NTN), a configuration parameter that indicates of a timing shift to use when communicating with the NTN;
receiving an uplink transmission that uses a time shift in the uplink frame timing, wherein the time shift is based on the configuration parameter.

Embodiment 14: The method of the preceding embodiment, wherein the configuration parameter includes multiple configuration parameters.

Embodiment 15: The method of the preceding embodiment, further comprising sending an indication for selection among the multiple configuration parameters.

Embodiment 16: The method of any of the previous embodiments, further comprising obtaining user data, and forwarding the user data to a host computer or a wireless device.

### GROUP C EMBODIMENTS

Embodiment 17: A wireless device, the wireless device comprising processing circuitry configured to perform any of the steps of any of the Group A embodiments; and power supply circuitry configured to supply power to the wireless device.

Embodiment 18: A base station for, the base station comprising: processing circuitry configured to perform any of the steps of any of the Group B embodiments; and power supply circuitry configured to supply power to the wireless device.

Embodiment 19: A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 20: A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

Embodiment 21: The communication system of the previous embodiment further including the base station.

Embodiment 22: The communication system of the previous 2 embodiments, further including the UE, wherein the UE is configured to communicate with the base station.

Embodiment 23: The communication system of the previous 3 embodiments, wherein:
the processing circuitry of the host computer is configured to execute a host application, thereby providing the user data; and
the UE comprises processing circuitry configured to execute a client application associated with the host application.

Embodiment 24: A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

Embodiment 25: The method of the previous embodiment, further comprising, at the base station, transmitting the user data.

Embodiment 26: The method of the previous 2 embodiments, wherein the user data is provided at the host computer by executing a host application, the method further comprising, at the UE, executing a client application associated with the host application.

Embodiment 27: A user equipment (UE) configured to communicate with a base station, the UE comprising a radio interface and processing circuitry configured to performs the of the previous 3 embodiments.

Embodiment 28: A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

Embodiment 29: The communication system of the previous embodiment, wherein the cellular network further includes a base station configured to communicate with the UE.

Embodiment 30: The communication system of the previous 2 embodiments, wherein:
the processing circuitry of the host computer is configured to execute a host application, thereby providing the user data; and
the UE's processing circuitry is configured to execute a client application associated with the host application.

Embodiment 31: A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

Embodiment 32: The method of the previous embodiment, further comprising at the UE, receiving the user data from the base station.

Embodiment 33: A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

Embodiment 34: The communication system of the previous embodiment, further including the UE.

Embodiment 35: The communication system of the previous 2 embodiments, further including the base station, wherein the base station comprises a radio interface configured to communicate with the UE and a communication interface configured to forward to the host computer the user data carried by a transmission from the UE to the base station.

Embodiment 36: The communication system of the previous 3 embodiments, wherein:
the processing circuitry of the host computer is configured to execute a host application; and
the UE's processing circuitry is configured to execute a client application associated with the host application, thereby providing the user data.

Embodiment 37: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 38: A method implemented in a communication system including a host computer, a base station and a user equipment (UE), the method comprising, at the host computer, receiving user data transmitted to the base station from the UE, wherein the UE performs any of the steps of any of the Group A embodiments.

Embodiment 39: The method of the previous embodiment, further comprising, at the UE, providing the user data to the base station.

Embodiment 40: The method of the previous 2 embodiments, further comprising:
at the UE, executing a client application, thereby providing the user data to be transmitted; and
at the host computer, executing a host application associated with the client application.

Embodiment 41: The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

Embodiment 42: A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

Embodiment 43: The communication system of the previous embodiment further including the base station.

Embodiment 44: The communication system of the previous 2 embodiments, further including the UE, wherein the UE is configured to communicate with the base station.

Embodiment 45: The communication system of the previous 3 embodiments, wherein:
the processing circuitry of the host computer is configured to execute a host application; and
the UE is configured to execute a client application associated with the host application, thereby providing the user data to be received by the host computer.

Embodiment 46: A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A embodiments.

Embodiment 47: The method of the previous embodiment, further comprising at the base station, receiving the user data from the UE.

Embodiment 48: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G Fifth-generation
5GS 5G System
BS Base Station
DCI Downlink Control Information
eMBB enhanced Mobile Broadband
EPC Evolved Packet Core
EPS Evolved Packet System
gNB 5G NodeB
GEO Geostationary Orbit
GPS Global Positioning System
HARQ Hybrid automatic repeat request
LEO Low Earth Orbit
LTE Long Term Evolution
mMTC Massive Machine Type Communications
MBB Mobile Broadband
MEO Medium Earth Orbit
Msg1 Message 1
Msg2 Message 2
Msg3 Message 3
NR New Radio
NTN Non-Terrestrial Network
OFDMA Orthogonal Frequency-Division Multiple Access
PDCCH Physical Downlink Control Channel
PDSCH Physical Downlink Shared Channel
PRACH Physical Random-Access Channel
PUCCH Physical Uplink Control Channel
PUSCH Physical Uplink Shared Channel
RAR Random Access Response
RRC Radio Resource Control
RTT Round-Trip Time
SIB System Information Block
SPS Semi-Persistent Scheduling
TA Timing Advance
UE User Equipment
URLLC Ultra-Reliable and Low Latency Communication

Those skilled in the art will recognize improvements and modifications to the embodiments of the present disclosure. All such improvements and modifications are considered within the scope of the concepts disclosed herein.

1. A method performed by a User Equipment (UE) comprising:
receiving, from a network node, a cell-specific offset for a scheduling timing and/or a UE-specific offset for the scheduling timing; and
determining the scheduling timing based on the cell-specific offset for the scheduling timing and/or the UE-specific offset for the scheduling timing.

2. The method of claim 1, wherein the scheduling timing comprises a Hybrid Automatic Repeat Request (HARQ) feedback timing, a Physical Uplink Shared Channel (PUSCH) timing, or a Msg3 timing.

3. The method of claim 2, further comprising transmitting a HARQ feedback, a PUSCH, or a Msg3 in accordance with the determined scheduling timing.

4. The method of claim 1, wherein:
receiving the cell-specific offset for the scheduling timing and/or the UE-specific offset for the scheduling timing comprises receiving both the cell-specific offset for the scheduling timing and the UE-specific offset for the scheduling timing;
wherein the UE-specific offset overwrites the cell-specific offset such that determining the scheduling timing comprises determining the scheduling timing based on the UE-specific offset, but not the cell-specific offset.

5. The method of claim 1, wherein:
receiving the cell-specific offset for the scheduling timing and/or the UE-specific offset for the scheduling timing comprises receiving both the cell-specific offset for the scheduling timing and the UE-specific offset for the scheduling timing; and
determining the scheduling timing comprises determining the scheduling timing based on a sum of the cell-specific offset and the UE-specific offset.

6. The method of claim 1, wherein:
the scheduling timing is a HARQ feedback timing for a particular Downlink Control Information, DCI, format;
receiving the cell-specific offset for the scheduling timing and/or the UE-specific offset for the scheduling timing comprises receiving the cell-specific offset for the scheduling timing, the cell-specific offset being a cell-specific offset for the HARQ feedback timing for the particular DCI format; and
determining the scheduling timing comprises determining the HARQ feedback timing based on a sum of a Physical Downlink Shared Channel, PDSCH-, to-HARQ feedback timing offset and the cell specific offset.

7. The method of claim 6, further comprising:
receiving, from the network node, system information that comprises a set of PDSCH-to-HARQ feedback offset values that map to a set of PDSCH-to-HARQ-timing indicator values; and
receiving a DCI that schedules a PDSCH, the DCI comprising a PDSCH-to-HARQ-timing-indicator field having one of the set of PDSCH-to-HARQ-timing indicator values to thereby indicate the PDSCH-to-HARQ feedback timing offset.

8. The method of claim 7, wherein determining the HARQ feedback timing based on the sum of the PDSCH-to-HARQ feedback timing offset and the cell-specific offset comprises determining the HARQ feedback timing as slot n+K_{1,offset}+K₁, where n is a slot in which the PDSCH is received, K_{1,offset} is the cell-specific offset, and K₁ is the PDSCH-to-HARQ feedback timing offset.

9. The method of claim 1, wherein:
receiving the cell-specific offset for the scheduling timing and/or the UE-specific offset for the scheduling timing comprises receiving system information including the cell-specific offset and/or receiving UE specific Radio Resource Control, RRC, signaling including the UE-specific offset.

10. The method of claim 1, wherein:
the scheduling timing is a HARQ feedback timing for a particular DCI format;
receiving the cell-specific offset for the scheduling timing and/or the UE-specific offset for the scheduling timing comprises receiving the cell-specific offset for the scheduling timing and receiving the UE-specific offset for the scheduling timing, the cell-specific offset being a cell-specific offset for the HARQ feedback timing for the particular DCI format and the UE-specific offset being a UE-specific offset for the HARQ feedback timing for the particular DCI format; and
determining the scheduling timing comprises determining the HARQ feedback timing based on a sum of a PDSCH-to-HARQ feedback timing offset and the cell-specific offset and/or the UE-specific offset.

11. The method of claim 10, wherein:
determining the HARQ feedback timing based on the sum of the PDSCH-to-HARQ feedback timing offset and the cell-specific offset comprises determining the HARQ feedback timing as slot n+K_{1,offset}+K₁, where n is a slot in which a PDSCH is received, K_{1,offset} is the cell-specific offset and/or the UE-specific offset, and K₁ is the PDSCH-to-HARQ feedback timing offset.

12. The method of claim 1, wherein:
the scheduling timing is the PUSCH timing for a PUSCH transmission;
receiving the cell-specific offset for the scheduling timing and/or the UE-specific offset for the scheduling timing comprises receiving a cell-specific offset for scheduling the PUSCH timing for a particular DCI format and/or receiving a UE-specific offset for scheduling the PUSCH timing for the particular DCI format, the cell-specific offset being a cell-specific offset for the PUSCH timing and the UE-specific offset being a UE-specific offset for the PUSCH timing; and
determining the scheduling timing comprises determining the PUSCH timing based on a sum of a Physical Downlink Control Channel-, PDCCH-, to-PUSCH timing offset and the cell-specific offset and/or the UE-specific offset.

13. The method of claim 12, wherein:
determining the PUSCH timing based on the sum of the PDCCH-to-PUSCH timing offset and the cell-specific offset and/or the UE-specific offset comprises determining a slot allocated for the PUSCH transmission as └n·2^{μ}^{_{PUSCH}}2^{μ}^{_{PDCCH}}┘+K_{2,offset}+K₂, where n is the slot with the scheduling DCI, and K₂ is based on the numerology of PUSCH, and μ_{PUSCH} and μ_{PDCCH} are the subcarrier spacing configurations for PUSCH and PDCCH, respectively, and K_{2,offset} is the cell-specific offset for PUSCH timing and/or the UE-specific offset for PUSCH timing.

14. The method of claim 1, wherein:
the scheduling timing is the PUSCH timing for a PUSCH transmission;
receiving the cell-specific offset for the scheduling timing and/or the UE-specific offset for the scheduling timing comprises receiving the cell-specific offset for the scheduling timing, the cell-specific offset being a cell-specific offset for the PUSCH timing.

15. The method of claim 1, wherein:
the scheduling timing is the PUSCH timing for a PUSCH transmission;
receiving the cell-specific offset for the scheduling timing and/or the UE-specific offset for the scheduling timing comprises receiving an offset value range of cell-specific offsets for the scheduling timing and receiving a cell-specific offset indicator indicating a cell-specific offset in the offset value range, the cell-specific offset being a cell-specific offset for the PUSCH timing; and
determining the scheduling timing comprises determining the PUSCH timing based on a sum of a Random Access Response (RAR) uplink (UL) grant-to-PUSCH timing offset and the cell-specific offset.

16. The method of claim 15, wherein:
determining the PUSCH timing based on the sum of the RAR UL grant-to-PUSCH timing offset and the cell-specific offset comprises determining a slot allocated for the PUSCH transmission as n+K_{2,offset}+K₂+Δ, where n is the slot in which the RAR message ends, K_{2,offset} is indicated by cell-specific offset, K₂ is indicated in the PUSCH time resource allocation field of RAR UL grant, and Δ is one of 2, 3, 4, and 6.

17. The method of claim 14, wherein:
receiving the cell-specific offset for the scheduling timing comprises receiving system information comprising the cell-specific offset.

18. A wireless device comprising:
processing circuitry and transceiver circuitry, the processing circuitry configured to execute stored instructions that cause the processing circuitry to perform operations comprising:
receiving, from a network node, a cell-specific offset for a scheduling timing and/or a User Equipment- (UE-) specific offset for the scheduling timing; and
determining the scheduling timing based on the cell-specific offset for the scheduling timing and/or the UE-specific offset for the scheduling timing.

19. The wireless device of claim 18, wherein the scheduling timing comprises a Hybrid Automatic Repeat Request (HARQ) feedback timing, a Physical Uplink Shared Channel (PUSCH) timing, or a Msg3 timing.

20. A method performed by a User Equipment (UE) comprising:
obtaining, from a network node, indication configuration of a set of Physical Downlink Shared Channel- (PDSCH-)-to-Hybrid Automatic Repeat Request (HARQ) timing offset values, the set of PDSCH-to-HARQ timing offset values being from an extended range of values that, for downlink control information, DCI, format 1_0 has an upper bound that is greater than 8 and, for DCI format 1_1 has an upper bound that is greater than 15;
receiving, from the network node, a DCI message comprising a PDSCH-to-HARQ timing offset indicator that indicates one of the set of PDSCH-to-HARQ timing offset values; and
determining a scheduling timing for HARQ feedback for a PDSCH scheduled by the DCI message based on the one of the set of PDSCH-to-HARQ timing offset values indicated by the PDSCH-to-HARQ timing offset indicator.

21. The method of claim 20, further comprising transmitting the HARQ feedback for the PDSCH in accordance with the determined scheduling timing.

22. The method of claim 20, wherein:
the DCI message uses the DCI format 1_0, and the extended range of values has an upper bound that is greater than 8.

23. The method of claim 20, wherein:
the DCI message uses the DCI format 1_1, and the extended range of values has an upper bound that is greater than 15.

24. A wireless device comprising:
processing circuitry and transceiver circuitry, the processing circuitry configured to execute stored instructions that cause the processing circuitry to perform operations comprising:
obtaining, from a network node, a configuration of a set of Physical Downlink Shared Channel-, PDSCH-, to-Hybrid Automatic Repeat Request timing offset values, the set of PDSCH-to-HARQ timing offset values being from an extended range of values that, for downlink control information, DCI, format 1_0 has an upper bound that is greater than 8 and, for DCI format 1_1 has an upper bound that is greater than 15;
receiving, from the network node, a DCI message comprising a PDSCH-to-HARQ timing offset indicator that indicates one of the set of PDSCH-to-HARQ timing offset values; and
determining a scheduling timing for HARQ feedback for a PDSCH scheduled by the DCI message based on the one of the set of PDSCH-to-HARQ timing offset values indicated by the PDSCH-to-HARQ timing offset indicator.

25-29. (canceled)
